(19) United States
(12) Patent Application Publication
(10) Pub. No.: US 2023/0211451 A1
(43) Pub. Date: Jul. 6, 2023

(54) INTELLIGENT ANALYSIS SYSTEM FOR MEASURING SIGNALS OF POLISHING PAD SURFACE, METHOD AND COMPUTER READABLE MEDIUM THEREOF

(71) Applicant: TA LIANG TECHNOLOGY CO., LTD., Taoyuan City (TW)

(72) Inventors: Hsien-Ming LEE, Taoyuan City (TW); Chun-Chen CHEN, Taoyuan City (TW); Ching-Tang HSUEH, Taoyuan City (TW)

(21) Appl. No.: 18/061,876

(22) Filed: Dec. 5, 2022

Related U.S. Application Data
(60) Provisional application No. 63/295,002, filed on Dec. 30, 2021.

(30) Foreign Application Priority Data
Dec. 30, 2021 (TW) 110149708

(51) Int. Cl. B24B 37/005; G06N 5/022

(52) U.S. Cl. CPC B24B 37/005; G06N 5/022

(57) ABSTRACT

An intelligent analysis system for measuring signals of polishing pad surface, a method and a computer readable medium thereof are provided. The intelligent analysis system includes a measurement signal capturing device and a measurement signal analysis device signally-connected to each other. After the measurement signal capturing device obtains the measurement signal of the measured polishing pad, an artificial intelligence model of the measurement signal analysis device is trained to classify the measurement signal to remove the interference caused by a water film on the polishing pad to obtain a better measurement signal, such that the intelligent analysis system can solve the problems of time-consuming, laborious and misjudgment caused by the classification of the measurement signal by the conventional technology.

### BACKGROUND

### 1. Technical Field

The present disclosure relates to an analysis technology for measuring signals, and more particularly, to an intelligent analysis system for measuring signals of a polishing pad surface, method and computer readable medium thereof.

### 2. Description of Related Art

The chemical-mechanical planarization (CMP) process uses a surface of a polishing pad (or called grinding pad) to polish an object to be processed or to level a surface of the object to be processed. Therefore, a state/condition of the surface of the polishing pad is important in the CMP process. As such, the surface of the polishing pad must be measured frequently to avoid undesired effects due to the state of the surface of the polishing pad in the manufacturing process. However, a wet polishing process is usually used in the CMP process, and the surface of the polishing pad thus has a water film, so measurement signals obtained by measuring the surface of the polishing pad often cannot be analyzed or prone to be distorted due to an interference of the water film, and the distorted measurement signals due to the interference must be discarded. Therefore, the measurement signals should be interpreted to exclude abnormal measurement signals (such as the aforementioned distorted measurement signals), while retaining normal measurement signals (i.e., the measurement signals without interfering by the water film), which is crucial for the measurement of the surface of the polishing pad.

In the past, whether the signal data are distorted is usually determined manually in the interpretation of the measurement signals. For instance, if the measurement signals are apparent, it is easy to determine whether the signal data are distorted; however, if the features generated by the measurement signals that have been interfered are not apparent, then manual methods cannot be used to determine whether the signal data are distorted. Furthermore, manual determination is usually time-consuming, laborious and error-prone, which would seriously affect the CMP process.

Hence, it can be seen from the above that the measurement signals are difficult to be determined and are easily misclassified in the prior art, and the manual determination method is both time-consuming and labor-intensive. Therefore, how to provide measurement signals that can be accurately classified for the subsequent analysis of the surface state of the polishing pad to increase the accuracy and efficiency of the analysis results and to reduce the impact of the CMP process using the wet polishing process has become an urgent issue to be solved in the art.

### SUMMARY

In view of the aforementioned shortcomings of the prior art, the present disclosure provides an intelligent analysis system for measuring signals on a polishing pad surface, the intelligent analysis system comprises: a measurement signal capturing device and a measurement signal analysis device, wherein the measurement signal capturing device is configured to measure the polishing pad surface to obtain a measurement signal, and the measurement signal analysis device is configured to receive the measurement signal from the measurement signal capturing device, wherein the measurement signal analysis device comprises an artificial intelligence model for analyzing the measurement signal, wherein the artificial intelligence model extracts a feature value from the measurement signal, and determines and classifies the measurement signal as a normal signal or an abnormal signal after training the feature value.

In one embodiment, the artificial intelligence model is an AlexNet model or a ResNet model.

In another embodiment, the measurement signal is raw data or filtered data.

In another embodiment, the artificial intelligence model is inputted with training signals comprising preset normal signals and preset abnormal signals in advance for training.

In another embodiment, the artificial intelligence model classifies and scores the training signals used for training, and then relabels the training signals with a classification score between 0.3 and 0.7 to provide the artificial intelligence model for retraining.

In another embodiment, the present disclosure further comprises a processing device configured for analyzing a performance index of the measurement signal determined and classified as the normal signal.

In another embodiment, the artificial intelligence model relabels the measurement signal with the performance index exceeding a performance index threshold, and the relabeled measurement signal is provided to the artificial intelligence model for training.

In another embodiment, the measurement signal capturing device comprises a probe element for transmitting a signal to the polishing pad and receiving the measurement signal.

The present disclosure further provides an intelligent analysis method of measuring signals of a polishing pad surface, the intelligent analysis method comprises: measuring the polishing pad surface by a measurement signal capturing device to obtain a measurement signal; receiving the measurement signal from the measurement signal capturing device by a measurement signal analysis device; extracting a feature value from the measurement signal by an artificial intelligence model of the measurement signal analysis device; and determining and classifying the measurement signal as a normal signal or an abnormal signal after training the feature value by the artificial intelligence model.

In one embodiment, the artificial intelligence model is an AlexNet model or a ResNet model.

In another embodiment, the measurement signal is raw data or filtered data.

In one embodiment, a step of extracting the feature value from the measurement signal by using the artificial intelligence model of the measurement signal analysis device to train the artificial intelligence model comprises: inputting training signals comprising preset normal signals and preset abnormal signals to the artificial intelligence model for training.

In another embodiment, the present disclosure further comprises classifying and scoring the training signals used for training by the artificial intelligence model, and then relabeling the training signals by the artificial intelligence model with a classification score between 0.3 and 0.7 to provide the artificial intelligence model for retraining.

In another embodiment, the present disclosure further comprises analyzing, by a processing device, a performance index of the measurement signal determined and classified as the normal signal.

In another embodiment, the present disclosure further comprises: relabeling the measurement signal by the artificial intelligence model when the artificial intelligence model determines that a performance index of the measurement signal exceeds a performance index threshold; and inputting the relabeled measurement signal to the artificial intelligence model for training.

In yet another embodiment, the measurement signal capturing device comprises a probe element for transmitting a signal to the polishing pad and receiving the measurement signal.

The present disclosure provides a computer program product configured to execute the above-mentioned intelligent analysis method after being loaded into a computer device.

As can be understood from the above, in the intelligent analysis system, method and computer program product of the present disclosure, the measurement signal measuring from the polishing pad surface is obtained via the measurement signal capturing device, and the measurement signal analysis device is used to classify the measurement signal by the trained artificial intelligence model to reduce the manual classification of the measurement signal and to further reduce the chance of misjudgment, so that the measurement signal can be accurately classified for the subsequent analysis of the surface state of the polishing pad to increase the accuracy and efficiency of the analysis results and reduce the impact of the CMP process using the wet polishing process. Further, the present disclosure further provides a model training method for the artificial intelligence model, and a method for enhancing the artificial intelligence model, so as to improve the accuracy of the classification result of the measurement signal by the artificial intelligence model.

### BRIEF DESCRIPTION OF THE DRAWINGS

FIG. 1 is a diagram showing a system framework of an intelligent analysis system for measuring signals of a polishing pad surface according to the present disclosure.

FIG. 2A and FIG. 2B are diagrams illustrating an artificial intelligence model of an AlexNet model or a ResNet model of the intelligent analysis system for measuring signals of the polishing pad surface according to one embodiment of the present disclosure.

FIG. 3A is a flow chart illustrating an intelligent analysis method for measuring signals of the polishing pad surface according to the present disclosure; and FIG. 3B is a flow chart illustrating a training of the artificial intelligence model according to the present disclosure.

FIG. 4 is a flow chart illustrating a measurement signal analysis of the intelligent analysis method for measuring signals of the polishing pad surface according to the present disclosure.

FIG. 5 is a detailed flow chart illustrating the measurement signal analysis of the intelligent analysis method for measuring signals of the polishing pad surface according to the present disclosure.

FIG. 6 is a flow chart illustrating a model training of the intelligent analysis method for measuring signals of the polishing pad surface according to the present disclosure.

FIG. 7 is a detailed flow chart illustrating the model training of the intelligent analysis method for measuring signals of the polishing pad surface according to the present disclosure.

### DETAILED DESCRIPTION

Implementations of the present disclosure are described below by embodiments. Other advantages and technical effects of the present disclosure can be readily understood by one of ordinary skill in the art upon reading the disclosure of this specification.

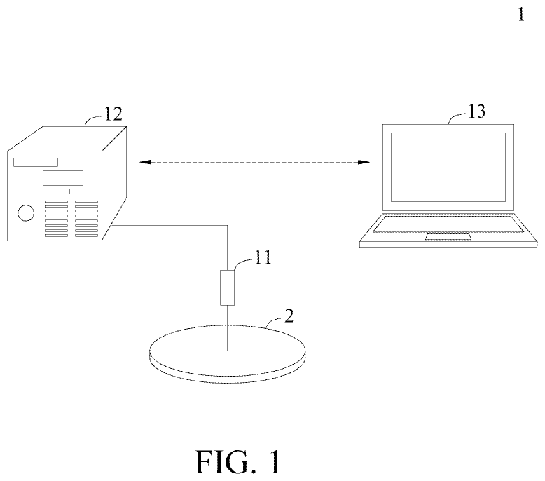

FIG. 1 is a diagram showing a system framework of an intelligent analysis system for measuring signals of a polishing pad surface according to the present disclosure, wherein the system is used for surface condition measurement of polishing pads in CMP process of wet polishing process. As shown in FIG. 1, an intelligent analysis system 1 for measuring signals of the present disclosure at least comprises a measurement signal capturing device 11 and a measurement signal analysis device 12, wherein the measurement signal capturing device 11 measures a polishing pad 2 to obtain a measurement signal, so that the measurement signal analysis device 12 performs training and determination according to the measurement signal by an artificial intelligence model therein to classify the measurement signal. The description of the intelligent analysis system 1 for measuring signals of the present disclosure is described in detail as follows.

The measurement signal capturing device 11 is used to measure a surface of the polishing pad 2 to obtain the measurement signals, wherein the measurement signals may be measurement data capturing within a period of time. In one embodiment, the measurement signal capturing device 11 has a probe element for transmitting and receiving signals, so as to transmit a signal to the polishing pad 2 to be measured and receive a returned measurement signal when the measurement signal is returned after the signal is transmitted through the surface of the polishing pad 2, and then the measurement signal is sent to the measurement signal analysis device 12, wherein the measurement signal capturing device 11 can select a corresponding probe element according to the type of the polishing pad 2 for obtaining better measurement results.

In one embodiment, the measurement signals of the present disclosure may be raw data or filtered data, wherein the raw data are unprocessed measurement signals, and the raw data are mainly used as a signal source when a performance index is to analyze a roughness of the polishing pad 2; in addition, the filtered data are the filtered measurement signals, and the filtered data are mainly used as a signal source when a performance index is to analyze a specific structure height of the polishing pad surface. Accordingly, when two types of polishing pads are different or the performance indexes analyzed are different, the present disclosure uses different signal sources to perform a model training of the artificial intelligence model with different signal features, so that the artificial intelligence model has a better classification ability/effect. In practical applications, the raw data and the filtered data are used for model training on the polishing pad with the performance index being roughness, in which the accuracy rates of the trained artificial intelligence model can reach about 97% and 79% respectively, the artificial intelligence model trained by raw data can accurately distinguish the OK measurement signals (e.g., good/normal measurement signals) and the NG measurement signals (e.g., not-good/abnormal measurement signals) for measuring the roughness of the polishing pad after model verification, and has a high accuracy; in addition, the raw data and the filtered data are used for model training on the polishing pad with the performance index being specific structure height, in which the accuracy rates of the trained artificial intelligence model are 98% and 99%, respectively. Although the accuracy rates of the two signal sources are both very high, the artificial intelligence model obtained by training with the filtered data can accurately determine the measurement signals obtained by measuring the polishing pad with the specific structure height as OK (e.g., good/normal) and NG (e.g., not-good/abnormal). For instance, the artificial intelligence model obtained by training with the filtered data has a better classification effect since features after being filtered or filtered features are more apparent and the signal features obtained by using the raw data to measure the polishing pad with a specific structure height are not apparent enough.

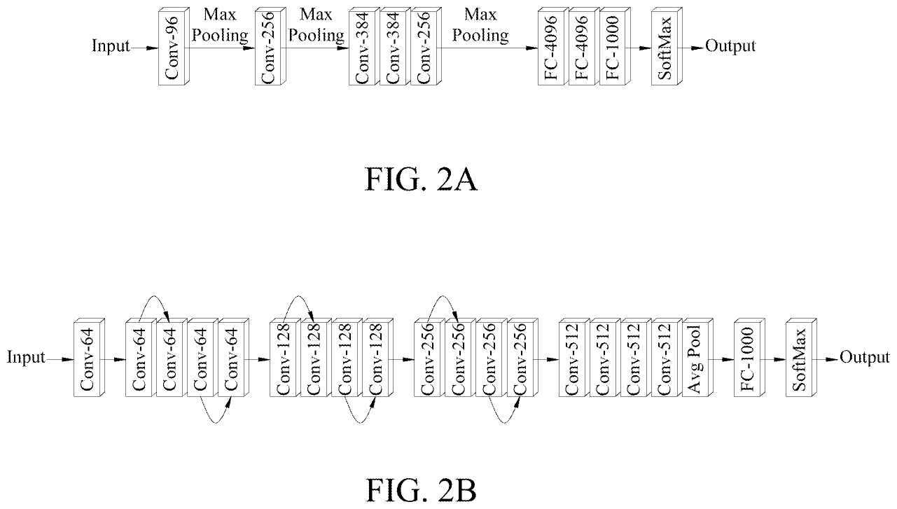

The measurement signal analysis device 12 is signally-connected to the measurement signal capturing device 11 to receive the measurement signals from the measurement signal capturing device 11, wherein the measurement signal analysis device 12 comprises an artificial intelligence model for training and analyzing the measurement signals. FIG. 2A and FIG. 2B are diagrams illustrating an artificial intelligence model of an AlexNet model or a ResNet model of the intelligent analysis system for measuring signals of the polishing pad surface according to one embodiment of the present disclosure. As shown in FIG. 2A and FIG. 2B, in an embodiment, the artificial intelligence model is an AlexNet model or a ResNet model, so that the measurement signal analysis device 12 extracts a feature value of the received measurement signal via the artificial intelligence model, and the measurement signal is determined and classified as a normal signal (e.g., good signal or OK signal) or an abnormal signal (e.g., not-good signal or NG signal) after the feature value is trained by the artificial intelligence model.

In one embodiment, when the artificial intelligence model is actually applied to classify the measurement signal, the artificial intelligence model has better accuracy for classifying the measurement signal after the artificial intelligence model is trained. That is, the artificial intelligence model is inputted with training signals comprising normal signals (e.g., preset normal signals) and abnormal signals (e.g., preset abnormal signals) in advance for training, so as to obtain an artificial intelligence model that can classify the measurement signals into normal signals and abnormal signals.

In addition, after the artificial intelligence model is trained with the training signals, the artificial intelligence model further classifies and scores the training signals to relabel the training signals with classification scores between 0.3 and 0.7 to provide the artificial intelligence model for retraining.

As shown in FIG. 1, the intelligent analysis system 1 for measuring signals of the present disclosure further comprises a processing device 13 for analyzing a surface state of the polishing pad 2 according to the measurement signals. That is, the processing device 13 is signally-connected with the measurement signal analysis device 12 to receive the measurement signal that has been determined and classified as a normal signal (i.e., a signal without water film interference) from the measurement signal analysis device 12, and the processing device 13 performs a performance index analysis on the received measurement signal to determine the surface state of the polishing pad 2 (e.g., to determine the surface roughness or the surface structure height of the polishing pad 2). For instance, after the measurement signal is determined and classified as a normal signal by the artificial intelligence model, the performance index analysis of the measurement signal is performed to determine a relationship between the performance index corresponding to the surface state of the polishing pad and a set performance index threshold, that is, whether a value of the performance index of the measurement signal is too large (e.g., exceeding the performance index threshold) or too small (e.g., not reaching the performance index threshold) is analyzed, thereby determining the surface state of the polishing pad.

In one embodiment, the intelligent signal analysis device for measuring signals of the present disclosure further stores a performance index threshold, wherein the performance index threshold can be a numerical range, so that when the artificial intelligence model analyzes the performance index of the measurement signal, the artificial intelligence model relabels the measurement signals with a value of the performance index exceeding the performance index threshold, and the relabeled measurement signal is provided to the artificial intelligence model for training, such that the artificial intelligence model can be enhanced to improve the accuracy of the classification results of the artificial intelligence model after the artificial intelligence model is established.

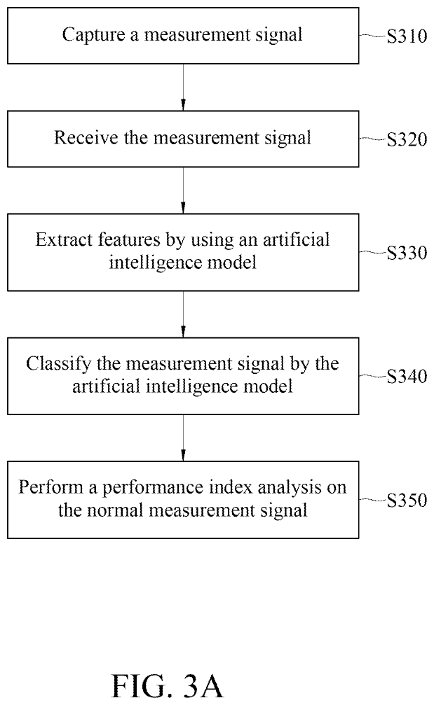

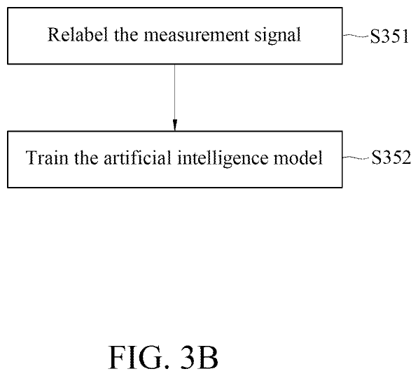

FIG. 3A is a flow chart illustrating an intelligent analysis method for measuring signals of the polishing pad surface according to the present disclosure, wherein the method is applied to the measurement of the surface state of the polishing pad in the CMP process of the wet polishing process. As shown in FIG. 3A, the intelligent analysis method for the measuring signals of the polishing pad surface of the present disclosure comprises the following steps.

In step S310, a measurement signal is captured. The present disclosure measures the polishing pad surface by arranging a measurement signal capturing device to obtain the measurement signal, wherein the measurement signal can be raw data or filtered data. In one embodiment, the measurement signal capturing device comprises a probe element for transmitting a signal to the polishing pad and receiving the measurement signal.

In step S320, the measurement signal is received. The present disclosure further arranges a measurement signal analysis device signally-connected with the measurement signal capturing device to receive the measurement signal from the measurement signal capturing device.

In step S330, features are extracted by using an artificial intelligence model. That is, the artificial intelligence model is established in the measurement signal analysis device to extract a feature value from the measurement signal. In one embodiment, the artificial intelligence model is an AlexNet model or a ResNet model (as shown in FIG. 2). When receiving the measurement signal, the measurement signal analysis device extracts the feature value of the measurement signal via the artificial intelligence model. In an embodiment, the extracted feature value can be a peak value of the measurement signal since the signal used is a one-dimensional time-domain signal.

In step S340, the measurement signal is classified by the artificial intelligence model. The artificial intelligence model classifies the measurement signal after training, so that the measurement signal analysis device classifies the measurement signal as a normal signal or an abnormal signal via the artificial intelligence model, and labels the normal signal or the abnormal signal for subsequent analysis procedures. The measurement signal is divided into a normal signal or an abnormal signal after the measurement signal is trained and classified by the artificial intelligence model, wherein the normal signal represents the measurement signal measured from the polishing pad surface without water film. On the contrary, the abnormal signal represents the measurement signal having a noise caused by the interference of water film on the measured surface. Therefore, the abnormal (or not-good) measurement signal should be discarded, and the performance index analysis should not be performed on the abnormal measurement signal to avoid the problem of inaccurate analysis results in the subsequent analysis procedures.

In step S350, the performance index analysis is performed on the normal measurement signals. In one embodiment, the present disclosure further comprises arranging a processing device to perform the performance index analysis on the measurement signal determined and classified as a normal signal so as to determine the surface state of the polishing pad.

FIG. 3B is a flow chart illustrating a training of the artificial intelligence model of the intelligence analysis method for measuring signals of the polishing pad surface according to the present disclosure. As shown in FIG. 3B, in one embodiment, after the performance index analysis is performed on the measurement signal, the measurement signal is labeled when the performance index is determined as abnormal by the processing device, so that the artificial intelligence model can perform the model training according to the measurement signal. The steps of relabeling the measurement signal and training the artificial intelligence model are described in the following.

In step S351, the measurement signal is relabeled. The measurement signal is relabeled when the artificial intelligence model determines that the performance index of the measurement signal exceeds the performance index threshold.

In step S352, the artificial intelligence model is trained. The artificial intelligence model is trained by inputting the relabeled measurement signal.

Accordingly, the artificial intelligence model is trained according to the measurement signal being the training signal after the performance index analysis to enhance the artificial intelligence model after training, so that the classification result of the measurement signal by the artificial intelligence model can be more accurate.

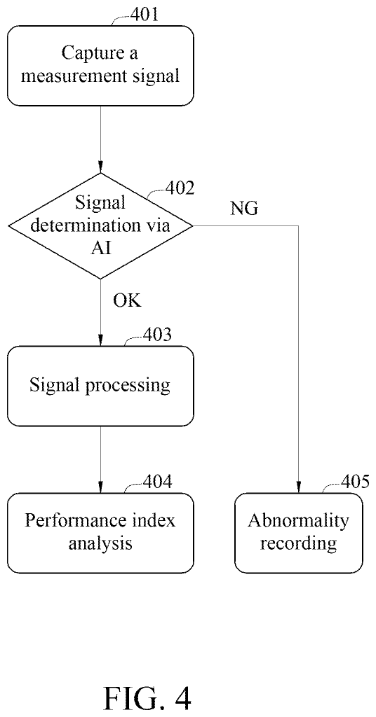

FIG. 4 is a flow chart illustrating a measurement signal analysis of the intelligent analysis method for measuring signals of the polishing pad surface according to the present disclosure. As shown in FIG. 4, in process 401, a measurement signal is captured; in process 402, a signal determination is performed via artificial intelligence (AI), that is, the artificial intelligence model is used to determine the measurement signal by artificial intelligence, and the measurement signal is classified after training, so as to classify the measurement signal into the normal measurement signal (e.g., OK/good measurement signal) and the abnormal measurement signal (e.g., NG/not-good measurement signal); in process 403 and process 404, signal processing is performed on the normal measurement signal and the performance index analysis is performed to obtain the surface state of the polishing pad, such as the roughness or structure height of the polishing pad surface; in process 405, abnormality of the measurement signal is recorded when the measurement signal is determined as abnormal.

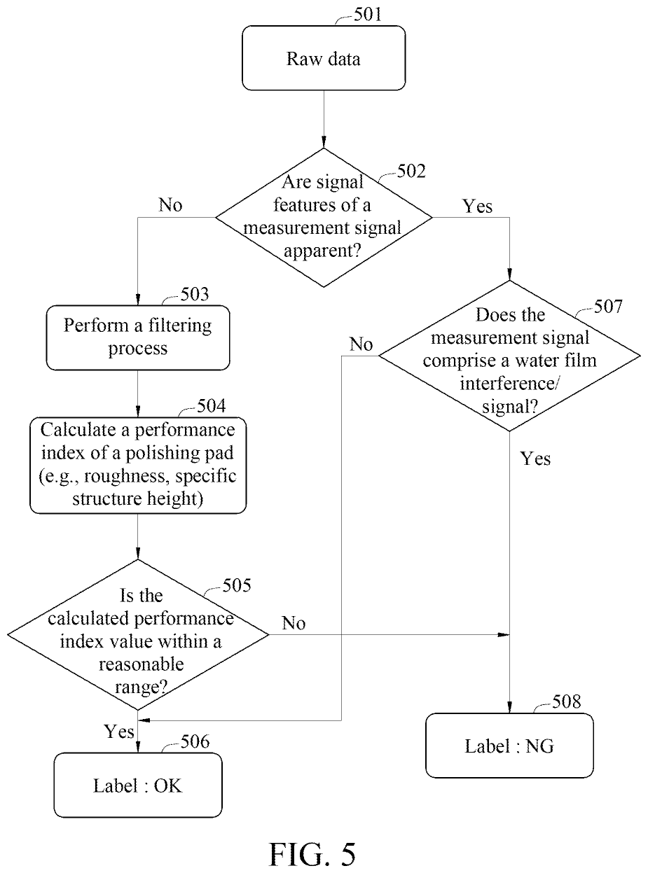

FIG. 5 is a detailed flow chart illustrating a measurement signal analysis of the intelligent analysis method for measuring signals of the polishing pad surface according to the present disclosure. As shown in FIG. 5, in process 501 to process 502, the measurement signals of captured raw data are classified via the artificial intelligence model, that is, the signal features of the measurement signals are extracted first and whether the signal features of the measurement signals are apparent are determined, which can be analyzed by using the feature value threshold, wherein if the signal features are not apparent, it is determined that there is no water film interference on the polishing pad. Then, in process 503, a filtering process is performed on the measurement signal, and in process 504, the performance index analysis of the polishing pad (such as roughness or specific structure height of the surface) is performed on the measurement signal, wherein the measurement signal of the raw data without filtering is analyzed to obtain the roughness of the polishing pad surface. In addition, analysis is performed according to the filtered measurement signal to obtain a specific structure height. In process 505, whether the calculated performance index is within a reasonable range is determined. If the calculated performance index is within a reasonable range, the analysis of the measurement signal is completed in process 506, and the measurement signal is marked as a normal (OK) measurement signal. On the contrary, if the performance index is not within a reasonable range, the measurement signal is marked as an abnormal (NG) measurement signal. Furthermore, if the signal features in process 502 are apparent, in process 507, whether the measurement signal comprises the water film interference/signal is determined. If the measurement signal is determined without comprising a water film interference/signal, it is marked as normal (OK) measurement signal. On the contrary, if the measurement signal comprises a water film interference/signal, then in process 508, the measurement signal is marked as an abnormal (NG) measurement signal.

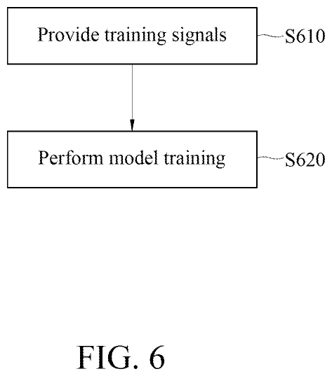

FIG. 6 is a flow chart illustrating a model training of the intelligent analysis method for measuring signals of the polishing pad surface according to the present disclosure. As shown in FIG. 6, the present disclosure performs the step of extracting feature values from the measurement signal by the artificial intelligence model of the intelligent device using the measurement signal to analyze the signal, which is to train the established artificial intelligence model, so as to improve the accuracy of the classification results of the measurement signal by the artificial intelligence model.

In step S610, training signals are provided. During training, several training signals used to train the artificial intelligence model are classified into normal signals and abnormal signals, and are marked respectively.

In step S620, model training is performed. The several training signals being classified are input to the artificial intelligence model for training.

In one embodiment, the model training of the present disclosure further comprises classifying and scoring each training signal used for training by the artificial intelligence model, and then relabeling the training signals with a classification score between 0.3 and 0.7 to provide the artificial intelligence model for retraining, thereby enhancing the classification effect of artificial intelligence model.

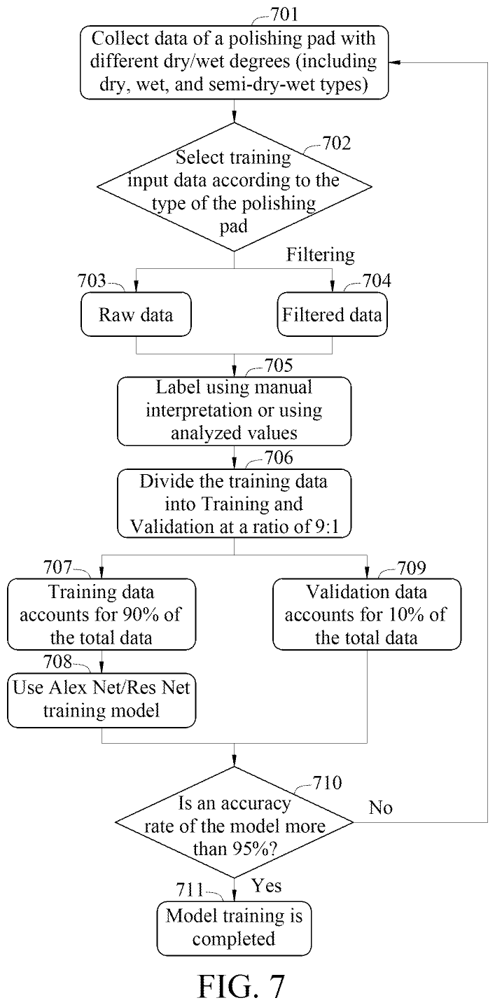

FIG. 7 is a detailed flow chart illustrating the model training of the intelligent analysis method for measuring signals of the polishing pad surface according to the present disclosure. As shown in FIG. 7, in process 701, the data of the polishing pad are collected, that is, the measurement signal is collected as the training signal, wherein the training signal comprises the measurement signal measured by the polishing pad surface in dry, wet and semi-dry-wet types. In process 702, the training signal for training can be selected according to the type of the polishing pad. For example, when the performance index being analyzed is the roughness of the polishing pad, the raw data is mainly used, and when the performance index being analyzed is the specific height structure of the polishing pad, the filtered data is mainly used. In addition, different signal sources can also be selected according to the determination effect of the artificial intelligence model. In process 703 to process 705, the unfiltered raw data and the filtered data being filtered are manually interpreted or the values of the performance index analyzed by the performance index analysis are used to classify and be labeled to form training signal. In process 706, the data used to train the model is set according to the ratio of training and verification, for example, a data volume of 9:1 for training the artificial intelligence model. In process 707 to process 709, the training of the artificial intelligence model is performed according to the above-mentioned ratio. In process 710 to process 711, the model effect is verified, so that when the classification effect of the artificial intelligence model reaches an accuracy rate of more than 95%, the training of the artificial intelligence model is completed; on the contrary, if the classification effect of the artificial intelligence model does not reach an accuracy rate of 95%, the artificial intelligence model will be retrained. Accordingly, after the artificial intelligence model is trained, the artificial intelligence model can achieve a high-accuracy classification effect when classifying the measurement signal. In addition, the present disclosure also enhances the above-mentioned artificial intelligence model, so that when the artificial intelligence model is actually applied to classify the measurement signals, the accuracy of the artificial intelligence model can be further improved based on the enhancement mechanism of the present disclosure.

Further, the computer program product of the present disclosure executes the above-mentioned methods and steps after being loaded by a computer, and the computer-readable recording medium (e.g., hard disk, floppy disk, CD, USB flash drive) of the present disclosure stores the computer program product. In addition, the computer program product can also be directly transmitted and provided on the Internet, such that the computer program product is a computer-readable program but not limited to an entity.

In view of above, the present disclosure provides an intelligent analysis system, method and computer program product for measuring signals of the polishing pad surface. The measurement signals measuring from the polishing pads are obtained via the measurement signal capturing device, and a classification on the measurement signal is performed by the measurement signal analysis device using the trained and constructed artificial intelligence model to reduce the manual classification of the measurement signals and to further reduce the chance of misjudgment, so that the subsequent analysis process will not perform the performance index analysis on the measurement signal interfered by the water film. In addition, the present disclosure provides a model training method for an artificial intelligence model, and a method for enhancing the artificial intelligence model, so as to improve the accuracy of the classification result of the measurement signal by the artificial intelligence model.

The above embodiments are provided for illustrating the principles of the present disclosure and its technical effect, and should not be construed as to limit the present disclosure in any way. The above embodiments can be modified by one of ordinary skill in the art without departing from the spirit and scope of the present disclosure. Therefore, the scope claimed of the present disclosure should be defined by the following claims.

What is claimed is:

1. An intelligent analysis system for measuring signals on a polishing pad surface, comprising:
a measurement signal capturing device configured to measure the polishing pad surface to obtain a measurement signal; and
a measurement signal analysis device configured to receive the measurement signal from the measurement signal capturing device, wherein the measurement signal analysis device comprises an artificial intelligence model for analyzing the measurement signal, wherein the artificial intelligence model extracts a feature value from the measurement signal, and determines and classifies the measurement signal as a normal signal or an abnormal signal after training the feature value.

2. The intelligent analysis system of claim 1, wherein the artificial intelligence model is an AlexNet model or a ResNet model.

3. The intelligent analysis system of claim 1, wherein the measurement signal is raw data or filtered data.

4. The intelligent analysis system of claim 1, wherein the artificial intelligence model is inputted with training signals comprising preset normal signals and preset abnormal signals in advance for training.

5. The intelligent analysis system of claim 4, wherein the artificial intelligence model classifies and scores the training signals used for training, and then relabels the training signals with a classification score between 0.3 and 0.7 to provide the artificial intelligence model for retraining.

6. The intelligent analysis system of claim 1, further comprises a processing device configured for analyzing a performance index of the measurement signal determined and classified as the normal signal.

7. The intelligent analysis system of claim 6, wherein the artificial intelligence model relabels the measurement signal with the performance index exceeding a performance index threshold, and the relabeled measurement signal is provided to the artificial intelligence model for training.

8. An intelligent analysis method of measuring signals of a polishing pad surface, the intelligent analysis method comprising:
measuring the polishing pad surface by a measurement signal capturing device to obtain a measurement signal;
receiving the measurement signal from the measurement signal capturing device by a measurement signal analysis device;
extracting a feature value from the measurement signal by an artificial intelligence model of the measurement signal analysis device; and
determining and classifying the measurement signal as a normal signal or an abnormal signal after training the feature value by the artificial intelligence model.

9. The intelligent analysis method of claim 8, wherein the artificial intelligence model is an AlexNet model or a ResNet model.

10. The intelligent analysis method of claim 9, wherein the measurement signal is raw data or filtered data.

11. The intelligent analysis method of claim 9, wherein a step of extracting the feature value from the measurement signal by using the artificial intelligence model of the measurement signal analysis device comprises inputting training signals comprising preset normal signals and preset abnormal signals to the artificial intelligence model for training.

12. The intelligence analysis method of claim 9, further comprising classifying and scoring the training signals used for training by the artificial intelligence model, and then relabeling the training signals by the artificial intelligence model with a classification score between 0.3 and 0.7 to provide the artificial intelligence model for retraining.

13. The intelligent analysis method of claim 12, further comprising analyzing, by a processing device, a performance index of the measurement signal determined and classified as the normal signal.

14. The intelligent analysis method of claim 12, further comprising:
relabeling the measurement signal by the artificial intelligence model when the artificial intelligence model determines that a performance index of the measurement signal exceeds a performance index threshold; and
inputting the relabeled measurement signal to the artificial intelligence model for training.

15. A computer program product configured to execute the intelligent analysis method of claim 8 after being loaded into a computer device.
